(19) United States
(12) Patent Application Publication
(10) Pub. No.: US 2022/0128338 A1
(43) Pub. Date: Apr. 28, 2022

(54) LIGHTWEIGHT HIGHLY FLEXIBLE ELECTROMAGNETIC BARRIER

(71) Applicant: Warwick Mills, Inc., New Ipswich, NH (US)

(72) Inventor: Charles A Howland, Temple, NH (US)

(73) Assignee: Warwick Mills, Inc., New Ipswich, NH (US)

(21) Appl. No.: 17/511,056

(22) Filed: Oct. 26, 2021

Related U.S. Application Data
(60) Provisional application No. 63/106,004, filed on Oct. 27, 2020.

(51) Int. Cl. F41H 3/02; A41D 31/32

(52) U.S. Cl. CPC F41H 3/02; A41D 2500/20; A41D 31/325

(57) ABSTRACT

An electromagnetic camouflage shield comprises a flexible conductive layer and a textile layer. The shield includes at least one outward facing fibrous face, and is creped with at least 5% increased elongation to enhance its flexibility and effective EM thickness. The conductive layer can be the textile layer, or a separate layer. In embodiments, the conductive layer is one of a woven that incorporates metallic yarns, a textile having an electroless plated metal coating, a metal mesh, a thin layer of foil, and an elastomeric layer having a conductive and/or ferrite filler. The textile layer can be a woven or non-woven. Embodiments are fashioned into shirts, pants, and/or other clothing, and can provide drape and moisture vapor transport for enhanced comfort.

### RELATED APPLICATIONS

This application claims the benefit of U.S. Provisional Application No. 63/106,004, filed Oct. 27, 2020, which is herein incorporated by reference in its entirety for all purposes.

### FIELD OF THE INVENTION

The invention relates to electromagnet shielding, and more particularly to flexible electromagnetic shielding.

### BACKGROUND OF THE INVENTION

Camouflage, which can be broadly defined as apparatus and methods for protecting covert mobile and stationary objects from detection, is an important requirement for many civilian and military applications. Applications include large, rigid constructions that protect stationary structures and mobile vehicles, as well as light, flexible tarps that can be easily packed and transported, and clothing that provides camouflage protection to a wearer without unduly limiting the movements of the wearer, and without undue trapping of heat and moisture.

In many cases, the primary requirement that must be met by camouflage is that it must mimic the visual appearance and other energy reflecting properties of a surrounding environment. To this end, camouflage typically presents colors and marking patterns that attempt to match colors and patterns in the visible background. Advanced camouflage systems also implement features sometimes referred to as “signature management,” whereby the camouflage attempts to mimic the reflective properties of a surrounding environment in the infrared and ultraviolet spectral ranges. Some camouflage systems also include humidity management features as well as “garnish” features that attempt to emulate the texture of the surrounding environment, for example the texture of leaves and other vegetation.

Signature management can also include an attempt to reduce the reflectivity of the camouflage system to radio waves and microwaves, so as to approximate the radio and microwave reflectivity of the environment, thereby reducing the likelihood that the camouflaged asset might be detected by radar and similar methods. In general, electromagnetic “EM” signature management can include EM shielding features that absorb and/or scatter radio waves and/or microwaves so that they are not redirected to their source.

Another fundamental requirement that must be met by camouflage in some applications is to shield an underlying asset so that all forms of energy that are generated by the asset, such as sound, heat, and electromagnetic emissions, are blocked, and do not radiate into the environment. In particular, some camouflage systems include an electrically conducing layer to block the emission of electromagnetic radiation.

Many rigid EM shielding systems are available. In particular, metal sheets, metal mesh, and conductive paints can all provide EM shielding for substantially rigid enclosures. However, it is often necessary for camouflage to be lightweight and flexible, so that it can be collapsed or folded into a compact space for transportation, or worn by a user, for example during combat. Unfortunately, it can be difficult to provide EM shielding that is highly flexible and/or wearable, especially for applications that require EM shielding over a broad range of frequencies.

Table 1 presents a brief summary of the frequencies and corresponding wavelengths that are used for various modes of communication and other purposes, and which may need to be blocked by a camouflage solution.

TABLE 1
EM frequencies and wavelengths used for
various communication modes and other purposes.

| Name | | | |
|---|---|---|---|
| of range | Abbr. | Range | Uses |
| Low | LF | 30-300 | Navigation, time signals, AM longwave |
| Frequency | | kHz | broadcasting (Europe and parts of Asia), |
| | | 10-1 km | RFID, amateur radio |
| Medium | MF | 300-3000 | AM (medium-wave) broadcasts, amateur |
| Frequency | | kHz | radio, avalanche beacons |
| | | 1000-100 | |
| | | km | |
| High | HF | 3-30 MHz | Shortwave broadcasts, citizens band radio, |
| Frequency | | 100-10 m | amateur radio and over-the-horizon aviation |
| | | | communications, RFID, over-the-horizon |
| | | | radar, automatic link establishment (ALE)/ |
| | | | near-vertical incidence skywave (NVIS) |
| | | | radio communications, marine and mobile |
| | | | radio telephony |
| Very high | VHF | 30-300 | FM, television broadcasts, line-of-sight |
| Frequency | | MHz | ground-to-aircraft and aircraft-to-aircraft |
| | | 10-1 m | communications, land mobile and maritime |
| | | | mobile communications, amateur radio, |
| | | | weather radio |
| Ultra high | UHF | 300-3000 | Television broadcasts, microwave oven, |
| Frequency | | MHz | microwave devices/communications, radio |
| | | 1-.1 m | astronomy, mobile phones, wireless LAN, |
| | | | Bluetooth, ZigBee, GPS and two-way |
| | | | radios such as land mobile, FRS and |
| | | | GMRS radios, amateur radio, satellite |
| | | | radio, Remote control Systems, ADSB |
| Super high | SHF | 3-30 GHz | Radio astronomy, microwave |
| frequency | | 100-10 | devices/communications, wireless LAN, |
| | | mm | DSRC, most modern radars, |
| | | | communications satellites, cable and |
| | | | satellite television broadcasting, DBS, |
| | | | amateur radio, satellite radio |

The interaction between EM radiation and a conductive barrier varies as a function of the frequency (or wavelength) of the EM energy. In particular, the ability of EM radiation to penetrate into a conductive material (“skin depth”) is greatest at low frequencies. Accordingly, extension of EM shielding to lower frequencies generally requires thicker layers of conductive material.

Suppressing EM radiation over a wide range of frequencies can be difficult in all cases, and is even more challenging for a lightweight and highly flexible system such as a portable camouflage tarp or wearable camouflage. This is because a continuous, flexible conductive layer that is thick enough to block lower frequency EM radiation will likely be too heavy and rigid for such applications. For example, a conductive metallic sheet that is fabricated as relatively thick, rolled foil will tend to be too stiff and heavy to be incorporated into clothing. On the other hand, very thin foils and metallic layers applied to textiles by electroless plating will typically be too thin to provide shielding at lower frequencies, due to the greater skin depth at those frequencies.

Providing moisture vapor transport can also be problematic, because higher frequency EM radiation will tend to penetrate through any gaps that are provided to enable the vapor transport. In addition, various wearable solutions further require acceptable drape and moisture vapor transport that can be difficult to provide using conventional approaches.

What is needed, therefore, is a lightweight, highly flexible EM shield or barrier that provides EM suppression and reflection over a wide range of EM frequencies while being suitable for use as a portable camouflage cover or incorporation into wearable garments.

### SUMMARY OF THE INVENTION

The invention is an electromagnetic shield or barrier that provides EM suppression and reflection over a wide range of EM frequencies while being sufficiently lightweight and flexible to enable incorporation of the shield into a portable camouflage cover or into a wearable garment. Embodiments further provide drape and moisture vapor transport for enhanced comfort when incorporated into clothing such as shirts, pants, undergarments, and jackets, where the term “jacket” is used herein to refer to an outer garment that cover the torso and arms of a wearer.

The EM barrier of the present invention comprises at least one woven or non-woven textile layer and one flexible, electrically conductive layer. The barrier is thermo-mechanically creped so as to increase its effective EM thickness, and also to increase the flexibility of the barrier, thereby improving its mechanical properties as well as its EM shielding properties. The textile layer can itself be the conductive layer, or the barrier can be a laminate that includes at least one textile layer and one separate conductive layer. The barrier includes at least one outer-facing fibrous layer that facilitates the thermo-creping process.

In embodiments, the flexible, electrically conductive layer can be a thin foil layer, a metallized polymer layer, a fabric layer with a metallic coating applied, for example, by electroless plating, a fabric that incorporates metallic fibers, or an elastomer layer that is filled with EM conducting and/or absorbing particles. Embodiments include a plurality of such conductive layers. In the case of porous conductive layers, such as metal meshes and metallized fabrics, the creping of the present invention also serves to extend the effectiveness of the shielding to higher frequencies by emulating a continuously conducting layer while maintaining the moisture vapor transport of the porous conductive layer.

Embodiments can be used as a highly portable and compact camouflage cover that can provide electromagnetic (“EM”) shielding of civilian and military personnel, systems, and assets. Other embodiments are fashioned into camouflage clothing. It should be noted, however, that even though much of the present disclosure is directed to camouflage embodiments, the present invention is not limited to camouflage applications, but is applicable to any circumstance where a lightweight, highly flexible EM barrier/scatterer/absorber is needed.

The thermo-mechanical creping of the present invention provides continuous, somewhat randomized disruption of the flat plains of the surface of the barrier. This creping process adds to the areal density of the barrier in proportion to the increase in elongation capability of the creped materials. Lighter weight materials are used in some embodiments because they are better adapted to the crepe process and remain low in mass even after creping. Embodiments incorporate fabrics woven from yarns of less than 500 denier and/or light non-woven layers that are between 3 and 12 oz/yd2. Because thermo-mechanical creping is a high temperature process, thermoset coatings are incorporated into various embodiments. And because the creping process depends upon friction, embodiments include a fibrous and/or otherwise textured surface on at least one, and in some embodiments both, of the thermal roll face and the doctor blade face of the EM shield as presented to the creping machine. The frictional coefficient of the fiber and/or other materials and the temperature at which the crimped material(s) takes a crease are important factors in creping.

The interaction of the laminate materials in the creping/crimping/creasing process is complex. One key to the process is the creasing/crimping temperature of the overall system. This can be defined by taking small samples of the laminate and folding and pressing them under controlled temperatures. When the creasing temperature is reached, the laminate will takes and hold a sharp crease. The creasing temperature of a laminate material is typically governed mainly by the creasing temperatures of included fibers and elastomers, whereas the metallic components do not play a key role in the crease formation during crimping. The organic components included in the laminate can range from fully thermoplastic to fully thermosetting. Even thermosets have a creasing temperature. However, thermosets tend to require higher temperatures for crease formation.

The thermo-mechanical creping process must bring the laminate to the crease holding temperature by both conductive and frictional heating. Because there is relative motion (sliding friction) between the main drum and the laminate, the surface of the material must not flow or transfer to the main creping drum during the steady state process. At the same time, the crease holding temperature of the material must be reached. So the use of temperature resistant materials on the outer faces of the laminate is required. There must also be harmony within the laminate system in that the melting temperatures of the internal adhesives cannot be so low as to become a low viscosity liquid at temperatures below the creping temperatures and creping forces. The creping process requires a set of materials that respond to the creping conditions in a unified way. In general, potential laminate materials can be grouped according to whether they have higher creasing temperatures or lower creasing temperatures. Materials for any given instantiation must then all be selected from the same group. For example, a meta aramid fiber is a high crease temperature material, having a crease temperature of approximately between 450° F. and 500° F. A meta aramid fiber would therefore be very difficult to crease if combined with an olefin thermoplastic adhesive that would flow at temperatures between 450° F. and 500° F.

In addition to improving the flexibility and frequency range of the EM shield, the small, randomly directed regions that are created on the creped surface result in a “surface roughness” that re-reflects and scatters incident EM radiation, resulting in a high EM scattering and low reflected return to the EM source.

Some garment embodiments are laminates wherein both external faces of the shield laminate are non-conducting fibrous textiles, with one or more EM conductive and/or absorbing layers included as internal layers of the laminate. In various garment embodiments that include a coating applied to a fabric, the coating is applied in a manner that avoids full coverage, so that at least some of the interstices between the fibers remain unblocked. In some of these embodiments, low cover mesh type fabrics are used as the coating substrates.

Embodiments incorporate coatings, adhesives, and/or other components that can withstand the temperatures that are applied during the thermo-creping process, so that the heat applied by the hot roll and the heat that is induced by the frictional interaction between the barrier and the doctor blade does not create a potential for melting and transfer of coatings and/or other materials to the hot roll or doctor blade. For this reason, embodiments employ thermoset adhesives. Fibers that are used in textiles in various embodiments include PET, Nylon, Rayon, acrylic, Tencel, Wool, Linin, and Cotton, all of which have moderate creasing temperatures that are in the range of between 250° F. and 370° F. Other embodiments incorporate para and meta aramid fibers, which have much higher creasing temperatures, and therefore require coatings, adhesives, and/or other components that can tolerate higher temperatures. Still other embodiments incorporate fibers such as polypropylene and polyethylene that have lower creasing temperatures.

Embodiments further include coloration and/or flame retardant treatments that impact the frictional behavior of the textile and therefore impact the creping process. And because level color dying is difficult to achieve after creping, embodiments incorporate the dying process into the barrier formation and/or pre-coating and layer integration steps before the barrier is creped, so that the dyeing process can be accomplished with the barrier in a fully planer form. The use of low flame or no-burn adhesives such a chloroprene are one example of a solution to the flame retarding requirement. The use of flame retardant additives in the adhesive layer and/or in the fiber is another example of how to implement flame retardation without adding a final flame retardant coating. In embodiments, the use of dye sublimation for printing of patterns on the textile layer or jig or jet dying for solids before coating and lamination are a means to address the processing limitations after crimping

It is notable that many EM absorbing layers that incorporate ferrite materials perform best at thicknesses greater than 1 mm, and in some cases at thicknesses greater than 4 mm, which are not practical for use in highly flexible, lightweight camouflage. However one of the results of surface creping is to create a barrier having EM properties that emulate the effect of a thickness of greater than 1-3 mm over significant portions of the barrier. This increase in equivalent EM thickness significantly increases the EM shielding effectiveness of the present invention.

The present invention is a lightweight, flexible and foldable electromagnetic barrier that includes a conductive layer; and a textile layer, said barrier having at least one fibrous outward face, and said barrier being creped, said creping resulting in an elongation increase of at least 5% in a crepe direction thereof.

In embodiments, the elongation increase is between 5% and 20%.

In any of the above embodiments, the conductive layer can be the textile layer. In some of these embodiments, the conductive layer includes conductive fibers incorporated therein. In some of these embodiments the conductive layer is woven from yarns that include a metallic core. And in some of these embodiments, the metallic core is a multi-filament core, and wherein the metallic core is surrounded by non-conductive cover fibers.

In any of the above embodiments where the conductive layer is the textile layer, the textile layer can have a metallic coating applied thereto. In some of these embodiments, the metallic coating is electroless plated to the textile layer.

In some embodiments, including some embodiments where the elongation increase is between 5% and 20%, the conductive layer is laminated to the textile layer. In some of these embodiments, the conductive layer is a layer of metal mesh. In other of these embodiments, the conductive layer is a layer of metal foil. In still other of these embodiments, the conductive layer is an elastomeric coating containing a filler that is at least one of electrically conductive and ferromagnetic. And in some of these embodiments a mass of the filler is between 5% and 25% of a mass of the elastomer coating when dry.

In any of any preceding embodiments, the textile layer can be a woven formed entirely from yarns that are less than 500 denier.

In any of any preceding embodiments, the barrier can be fashioned as an article of clothing that can be worn in place of conventional clothing. In some of these embodiments, the barrier is fashioned as one of a shirt, pants, an undershirt, undershorts, and a jacket configured to fully cover the arms and torso of a wearer.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates the process of creping as applied to the present invention;

FIG. 2 illustrates an exemplary combination of layers in a laminate embodiment of the present invention before creping;

FIG. 3A illustrates the process of forming a first example embodiment of the present invention;

FIG. 3B illustrates the combination of layers of the first example embodiment shown before creping;

FIG. 4A illustrates the process of forming a second example embodiment of the present invention;

FIG. 4B illustrates the combination of layers of the second example embodiment shown before creping;

FIG. 5A illustrates the process of forming a third example embodiment of the present invention; and

FIG. 5B illustrates the combination of layers of the third example embodiment shown before creping.

### DETAILED DESCRIPTION

The present invention is an electromagnetic shield or barrier that provides EM suppression and reflection, absorption, and/or scattering over a wide range of EM frequencies while being sufficiently lightweight and flexible to enable incorporation of the shield into a portable camouflage cover or wearable garment. Embodiments further provide drape and moisture vapor transport for enhanced comfort when incorporated into clothing such as shirts, pants, undergarments, and jackets, where the term “jacket” is used herein to refer to an outer garment that cover the torso and arms of a wearer.

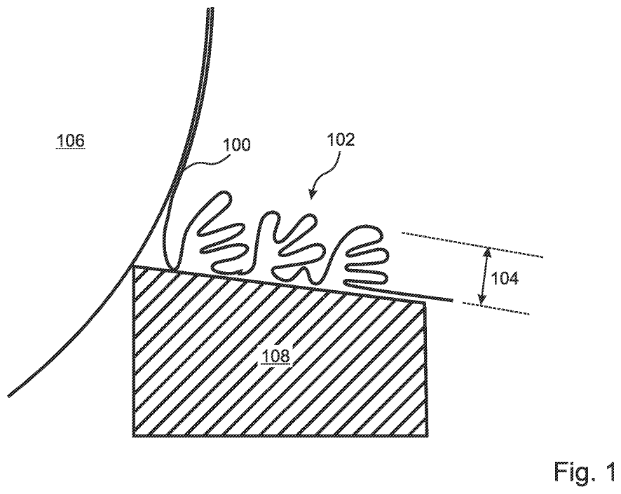

With reference to FIG. 1, the EM barrier 100 of the present invention comprises at least one woven or non-woven textile layer and one flexible, electrically conductive layer. The barrier 100 is thermo-mechanically creped 102 so as to increase its effective EM thickness 104, and also to increase the flexibility of the barrier 100, thereby improving its mechanical properties as well as its EM shielding properties. The textile layer can itself be the conductive layer, or the barrier can be a laminate that includes at least one textile layer and one separate conductive layer. The barrier 100 includes at least one outer-facing fibrous layer that facilitates the thermo-creping process.

In embodiments, the flexible, electrically conductive layer can be a thin foil layer, a metallized polymer layer, a fabric layer with a metallic coating applied, for example, by electroless plating, a fabric that incorporates metallic fibers, or an elastomer layer that is filled with EM conducting and/or absorbing particles. Embodiments include a plurality of such conductive layers. In the case of porous conductive layers, such as metal meshes and metallized fabrics, the creping 102 of the present invention also serves to extend the effectiveness of the barrier 100 to higher frequencies by emulating a continuously conducting layer while maintaining the moisture vapor transport of the porous conductive layer.

Embodiments can be used as a highly portable and compact camouflage cover that can provide electromagnetic (“EM”) shielding of civilian and military personnel, systems, and assets. Other embodiments are fashioned into camouflage clothing. It should be noted, however, that even though much of the present disclosure is directed to camouflage embodiments, the present invention is not limited to camouflage applications, but is applicable to any circumstance where a lightweight, highly flexible EM barrier/scatterer/absorber is needed.

As is illustrated in FIG. 1, the thermo-mechanical creping 102 of the present invention provides continuous, somewhat randomized disruption of the flat plains of the surface of the shield 100. This creping process adds to the effective EM density of the barrier 100 in proportion to the increase in elongation capability of the creped materials. Lighter weight materials are used in some embodiments because they are better adapted to the crepe process and remain low in mass even after creping. Embodiments incorporate fabrics woven from yarns of less than 500 denier and/or light non-woven layers that are between 3 and 12 oz/yd2.

As is illustrated in FIG. 1, the thermo-mechanical creping process includes pre-heating the barrier 100 on a hot roller 106 and then causing the barrier 100 to contact a “doctor blade” 108, thereby causing the barrier material 100 to be compressed backward onto itself, and leading to a somewhat randomized pattern of folding and creasing 102. Because thermo-mechanical creping is a high temperature process, thermoset coatings and adhesives are incorporated into various embodiments. And because the creping process depends upon friction between the barrier material 100 and the roller 106, and between the barrier material 100 and the doctor blade 108, embodiments include a fibrous and/or otherwise textured surface on at least one, and preferably both outward faces of the barrier 100, i.e. the thermal roll face and the doctor blade face of the EM barrier 100 as presented to the creping machine 106, 108. The frictional coefficient of the fiber and/or other materials and the temperature at which the crimped material(s) takes a crease, as defined above, are important factors in creping.

In addition to improving the flexibility and frequency range of the EM barrier 100, the small, randomly directed regions 102 that are created on the structure of a creped surface result in a “surface roughness” that re-reflects and scatters incident EM radiation, resulting in a high EM scattering and low reflected return from these materials.

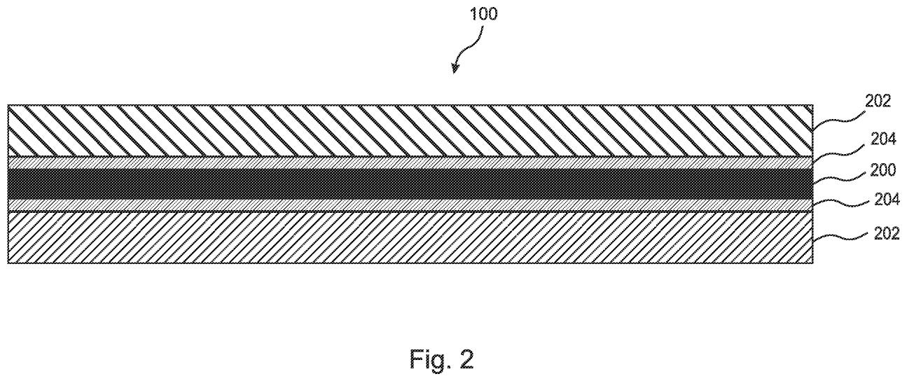

With reference to FIG. 2, some embodiments are laminates 100 wherein both external faces 202 of the shield laminate are non-conducting fibrous textiles, with one or more EM conductive and/or absorbing layers 200 laminated by adhesive layers 204 as internal layers of the laminate 100. In various garment embodiments that include a coating applied to a fabric, the coating is applied in a manner that avoids full coverage, so that at least some of the interstices between the fibers remain unblocked. In some of these embodiments, low cover mesh type fabrics are used as the coating substrates. Note that FIG. 2 illustrates the structure of the barrier 100 before creping.

Embodiments incorporate coatings, adhesives 204, and/or other components that can withstand the temperatures that are applied during the thermo-creping process, so that the heat applied by the hot roll 106 and the heat that is induced by the frictional interaction between the shield 100 and the doctor blade 108 does not create a potential for melting and transfer of coatings and/or other materials to the hot roll 106 or doctor blade 108. For this reason, embodiments employ thermoset adhesives 204. Fibers that are used in textiles in various embodiments include PET, Nylon, Rayon, acrylic, and Tencel, all of which have moderate creasing temperatures. Other embodiments incorporate para and meta aramid fibers, which have much higher creasing temperatures, and therefore require coatings, adhesives, and/or other components that can tolerate higher temperatures. Still other embodiments incorporate fibers such as polypropylene and polyethylene that have lower creasing temperatures.

Embodiments further include coloration and/or flame retardant treatments that impact the frictional behavior of the textile and therefore impact the creping process. And because level color dying is difficult to achieve after creping, embodiments incorporate the dying process into the shield formation and/or pre-coating and layer integration steps before the shield is creped, so that the dyeing process can be accomplished with the shield in a fully planer form.

### EXAMPLES

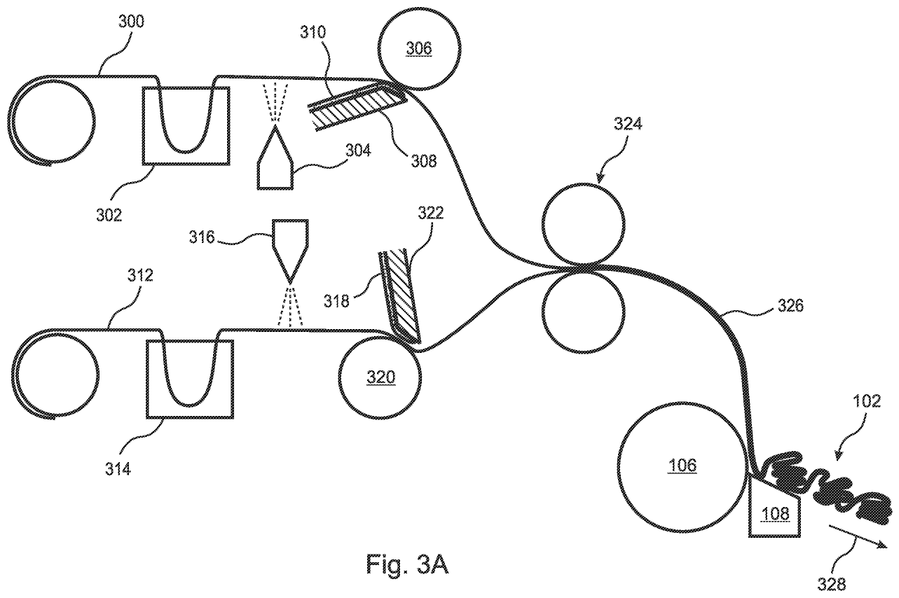

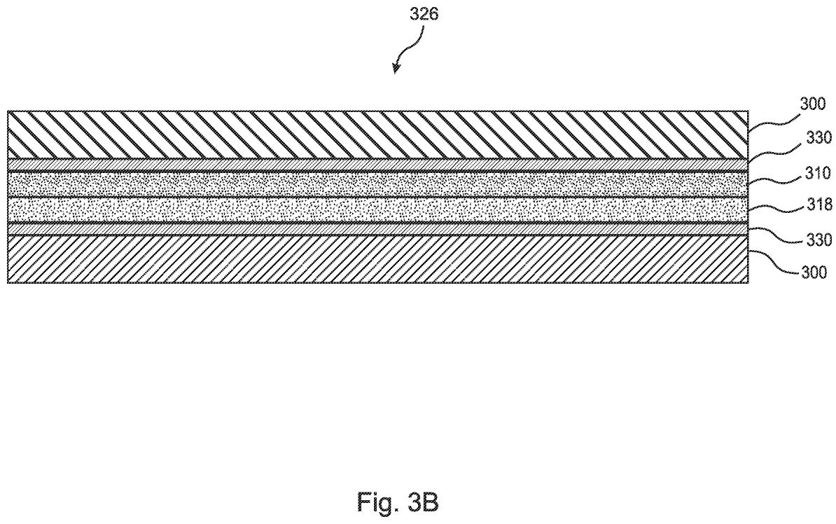

With reference to FIG. 3A, in a first exemplary embodiment a PET warp knit mesh 300 of 100 d denier yarns is scoured 302, after which an isocyanate primer 304 is applied. A coating 310 containing both conductive carbon black and powdered graphite is then applied to the textile 300 using a coating roll 306 and doctor blade 308. A second ply 312 of the same textile is scoured 314 and primed 316, and a neoprene coating 318 containing ferrite spherical powder is applied using a coating roll 320 and a doctor blade 322. The two coated textiles 300, 312 are then wet married 324 to each other, after which the combined textile 326 is creped 102 on a heated drum 106 with a doctor blade 108 to produce an increase in elongation of between 5% and 15% in the crepe direction 328.

The layers that are included in the laminate 326 of the first exemplary example are illustrated in FIG. 3B, where the figure illustrates the structure of the laminate 326 before creping. In particular, the two outer layers 330 of PET warp knit mesh are both primed 330 on their inward-facing surfaces, with the coating 310 containing carbon black and powdered graphite and the neoprene coating 318 containing ferrite powder sandwiched together in the center of the laminate 326. Accordingly, the two outer faces of the laminate 326 are both uncoated surfaces of the PET warp knit mesh layers, which provide optimal surfaces for frictional contact with the hot roller 106 and doctor blade 108 of the creping apparatus.

It is notable that many EM absorbing layers 318 that incorporate ferrite materials perform best at thicknesses greater than 1 mm, and in some cases at thicknesses greater than 4 mm, which are not practical for use in highly flexible, lightweight camouflage 326. However one of the results of surface creping 102 is to create a barrier layer 318 having EM properties that emulate the effect of a layer thickness of greater than 1-3 mm over significant portions of the barrier 326. This increase in equivalent EM thickness significantly increases the EM shielding effectiveness of the present invention.

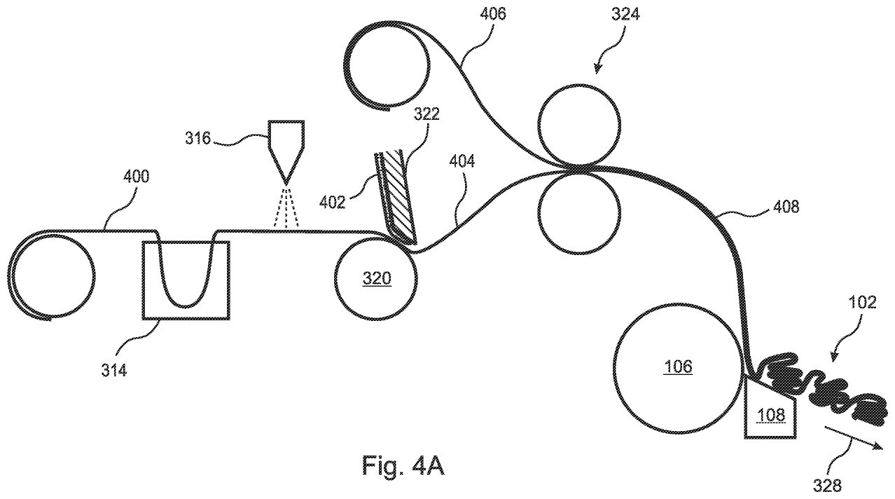

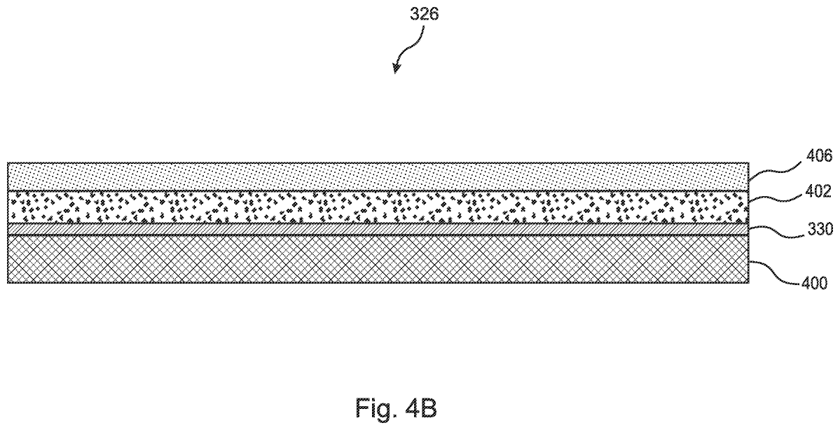

With reference to FIG. 4A, in a second exemplary embodiment a core spun 300 denier cotton cover fiber is applied over a copper multi-filament core having a diameter of 0.006 inches, and the resulting yarn is woven in a leno looper weave with a stable construction having 19×19 warp and sley. The resulting textile 400 is scoured 314, primed 316, and transfer coated with a soft neoprene cement 402 having ferrite and carbon black fillers at between 5% and 25% filler to dry weight of coating using a coating roll 320 and doctor blade 322. The coated textile 404 is then wet married 324 to a cellulosic nonwoven textile layer 406. The resulting laminate 408 therefore has one outward face that is core spun, while the other outward face is a nonwoven face. The laminate 408 is creped on a heated roll 106 with a doctor blade 108 to produce between 5% and 20% increased elongation in the crepe direction 328.

The layers that are included in the laminate 408 of the second exemplary example are illustrated in FIG. 4B, where the figure illustrates the structure of the laminate 408 before creping. In particular, the bottom layer of conductive textile 400 comprising copper multi-filament cores covered by cotton fibers is primed 330 and covered by a coating 402 of soft neoprene cement filled with ferrite and carbon black. The neoprene coating 402 is covered by the non-woven layer 406, such that the downward-facing outer surface, as shown in the drawing, is an uncoated woven face while the upward-facing surface is a non-woven face.

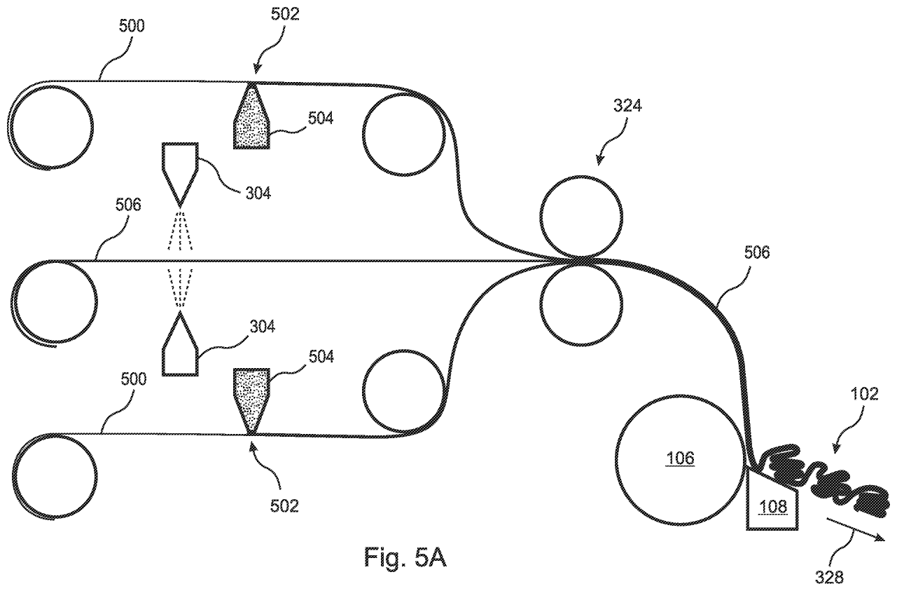

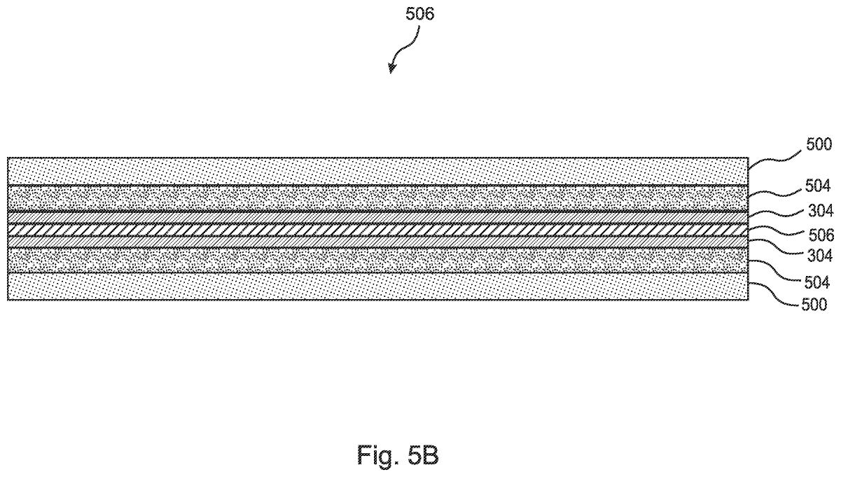

With reference to FIG. 5A, in a third exemplary embodiment a top layer 500 of fabric made from a PET nonwoven core thermal bonded to a sheath at 2 ounces per square yard is wet married 502 to a neoprene coating 502 containing spherical ferrite powder, carbon black, and/or graphite fillers at between 10% and 25% mass of the dry coating. An aluminum foil layer 506 of 0.0005″ thickness is primed 304 and then wet married 324 to the neoprene coating 504 of the PET layer 500. A bottom layer is prepared that is identical to the top layer, and is wet married 324 to the other side of the foil layer 506. The resulting laminate 506, which presents two nonwoven outward faces, is creped 102 on a heated roll 106 with a doctor blade 108 that enables an elongation of the laminate 506 of between 5% and 20% in the crepe direction 328.

The layers that are included in the laminate 506 of the third exemplary example are illustrated in FIG. 5B, where the figure illustrates the structure of the laminate 506 before creping. In particular, the aluminum foil layer 506 is primed 304 on both sides and sandwiched between top and bottom layers of PET non-woven 500 to which filled neoprene coatings 504 have been applied. As a result, both of the outward faces of the laminate 506 are uncoated non-woven faces.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications without departing from the spirit thereof. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A lightweight, flexible and foldable electromagnetic barrier comprising:
a conductive layer; and
a textile layer;
said barrier having at least one fibrous outward face; and
said barrier being creped, said creping resulting in an elongation increase of at least 5% in a crepe direction thereof.

2. The barrier of claim 1, wherein the elongation increase is between 5% and 20%.

3. The barrier of claim 1, wherein the conductive layer is the textile layer.

4. The barrier of claim 3, wherein the conductive layer includes conductive fibers incorporated therein.

5. The barrier of claim 4, wherein the conductive layer is woven from yarns that include a metallic core.

6. The barrier of claim 5, wherein the metallic core is a multi-filament core, and wherein the metallic core is surrounded by non-conductive cover fibers.

7. The barrier of claim 3, wherein the textile layer has a metallic coating applied thereto.

8. The barrier of claim 7, wherein the metallic coating is electroless plated to the textile layer.

9. The barrier of claim 1, wherein the conductive layer is laminated to the textile layer.

10. The barrier of claim 9, wherein the conductive layer is a layer of metal mesh.

11. The barrier of claim 9, wherein the conductive layer is a layer of metal foil.

12. The barrier of claim 9, wherein the conductive layer is an elastomeric coating containing a filler that is at least one of electrically conductive and ferromagnetic.

13. The barrier of claim 12, wherein a mass of the filler is between 5% and 25% of a mass of the elastomer coating when dry.

14. The barrier of claim 1, wherein the textile layer is a woven formed entirely from yarns that are less than 500 denier.

15. The barrier of claim 1, wherein the barrier is fashioned as an article of clothing that can be worn in place of conventional clothing.

16. The barrier of claim 15, wherein the barrier is fashioned as one of:
a shirt;
pants;
an undershirt;
undershorts; and
a jacket configured to fully cover the arms and torso of a wearer.
